(19) United States
(12) Patent Application Publication
(10) Pub. No.: US 2011/0153731 A1
(43) Pub. Date: Jun. 23, 2011

(54) METHOD OF UPDATING CONTENT INFORMATION ASSOCIATED WITH CONTENT BEING SERVICED IN STREAMING SERVER GROUP

(75) Inventors: Soon-heung Jung, Daejeon (KR); Jeong Ju Yoo, Daejeon (KR); Won Ryu, Daejeon (KR)

(73) Assignee: Electronics and Telecommunications Research Institute, Daejeon (KR)

(21) Appl. No.: 12/971,522

(22) Filed: Dec. 17, 2010

(30) Foreign Application Priority Data
Dec. 21, 2009 (KR) 10-2009-0128052

(51) Int. Cl. G06F 15/16

(52) U.S. Cl. 709/203

(57) ABSTRACT

Provided is a method of updating content information associated with a content being serviced in a streaming server group. The content information updating method may include: monitoring whether a new streaming server joins a streaming server group servicing the same category of a content; updating content information associated with the content being serviced in the streaming server group, and transferring the updated content information to a client when the new streaming server joins; and providing a content service via the new streaming server according to a request of the client.

### CROSS-REFERENCE TO RELATED APPLICATION

This application claims the benefit of Korean Patent Application No. 10-2009-0128052, filed on Dec. 21, 2009, in the Korean Intellectual Property Office, the disclosure of which is incorporated herein by reference.

### BACKGROUND

1. Field of the Invention

Embodiments of the present invention relate to a method of updating content information associated with a content being serviced in a streaming server group. More particularly, embodiments of the present invention relate to a method that may update content information associated with a content being serviced in a streaming server group when a new streaming server joins the streaming server group servicing the same category of a content, and transfer the updated content information to a user and thereby may provide the user's desired streaming service to the user.

2. Description of the Related Art Generally, for a multimedia content streaming service using an Internet Protocol (IP) network, a Hypertext Transport Protocol (HTTP), a Real-time Streaming Protocol (RTSP), a Session Description Protocol (SDP), a Real-time Transport Protocol (RTP), and an RTP Control Protocol (RTCP) may be employed. An operation process thereof is shown in FIG. 1.

Referring to FIG. 1, when a client 110 desires to receive a service from a streaming server 130, a client 110 may need to obtain content information associated with a corresponding content and session information, that is, source description associated with the content information.

Generally, to receive a multimedia content streaming service, the client 110 may select the client 110′s desired content using a web searcher 111.

A web server 120 may transfer, to the client 110, content information in an SDP-based format (1). Also, the web server 120 may transfer, to the client 110, a Universal Resource Locator (URL) where it is possible to obtain the content information, and the client 110 may obtain the content information in the SDP-based format according to “RTSP DESCRIBE METHOD” using the obtained URL (2). Next, the client 110 may interpret the transferred content information and access the streaming server 130 to thereby receive the service. In this instance, a change may frequently occur in content information associated with the service being serviced. For example, while providing a streaming service only for a video content, an audio content may be added or a text content may be added. For this, “RTSP” may include “ANNOUNCE METHO” and thus may transfer changed content information to the client 110 in real time using the SDP. The client 110 may verify the changed content information and may use the changed content or may continuously use the existing content using a media player 112.

When a plurality of streaming servers or a single streaming server provides a streaming service with respect to the same category of a content, content information associated with the content provided from the streaming server may be generally known through an access to the web server 120. For example, the Internet homepage of a broadcasting corporation enables a user to perform search using the web searcher 111 by diversifying the quality of the same content. When the user selects the content, the user may be informed of information associated with the streaming server 130 that provides the selected content. In this case, the user may select and use, using only the web searcher 111, a quality, a viewpoint, and the like with respect to the same category of the content being serviced. Here, the same category of the content denotes a content including the same description and indicating the same subject. For example, when the same description of the content has a quality or a dimension different from an existing content according to a resolution, an aspect rate, and a bitrate, or when the same sport is being broadcasted, a viewpoint, that is, a position of a camera may be different and thus changed information may be transferred to the user.

Accordingly, when a new streaming server of providing a different quality or viewpoint joins a streaming server group servicing the same category of a content to thereby provide a service, there is a desire for a scheme that may receive the service from the new streaming server.

### SUMMARY

An aspect of the present invention provides a method of updating content information that may generate corresponding content information and transfer the content information to a user when a new streaming server of providing a different quality or viewpoint joins a streaming server group servicing the same category of a content to thereby provide a service, and thereby enables a client to access a web server and to move to the new streaming server to receive the service without verifying updated information of the streaming server group.

According to an aspect of the present invention, there is provided a method of updating content information, including: monitoring whether a new streaming server joins a streaming server group servicing the same category of a content; updating content information associated with the content being serviced in the streaming server group, and transferring the updated content information to a client when the new streaming server joins; and providing a content service via the new streaming server according to a request of the client.

The updating and the transferring may include: receiving join information from a web server when the new streaming server joins; updating the content information based on a Session Description Protocol (SDP); and transferring the updated content information to the client.

The method may further include transferring the updated content information to the streaming server group servicing the same category of the content.

The updating and the transferring may include transferring, by the web server, the updated content information to the client using the content.

The updating and the transferring may include transferring, by the web server, the updated content information to the client when the client periodically requests the web server for the updated content information.

The updating and the transferring may include transferring, by the web server, the updated content information to the client when the content information is updated. The web server may manage the content information.

The method may further include: interpreting, by the client, the updated content information; providing the interpreted content information to a user; and providing a user interface enabling the user to select a streaming service with respect to a content of a class desired by the user.

According to another aspect of the present invention, there is provided a method of updating content information, the method including: accessing, by a client, a web server and selecting a content corresponding to a desired streaming service; providing, by the web server, content information associated with the selected content to the client; accessing, by the client, a first streaming server so as to receive a service for a first class content; receiving, by the client, the service for the first class content from the first streaming server; starting, by a second streaming server providing a streaming service with respect to the same content, a service and transferring content information associated with the content to the web server; adding, by the web server, the transferred content information and transferring the added content information to a streaming server group providing the streaming service with respect to the same content; transferring, by each streaming server included in the streaming server group, updated content information to the client; verifying, by the client, whether the second streaming server is servicing a second class content with respect to the same content, and terminating the service with the first streaming server depending on a verification result; and receiving, by the client, the service for the second class content from the second streaming server. The streaming server group may include the first streaming server and the second streaming server.

The providing of the content information associated with the selected content may include providing, by the web server, session information associated with content information of the first class content to the client when the first streaming server provides the first class content to the client.

According to still another aspect of the present invention, there is provided a method of updating content information, the method including: accessing, by a client, a web server and selecting a content corresponding to a desired streaming service; providing, by the web server, content information associated with the selected content to the client; accessing, by the client, a first streaming server so as to receive a service for a secure digital (SD) content; receiving, by the client, the service for the SD content from the first streaming server; starting, by a second streaming server providing a streaming service with respect to the same content, a service and transferring content information associated with the content to the web server; adding, by the web server, the transferred content information and transferring the added content information to the client; verifying, by the client, whether the second streaming server is servicing a three-dimensional (3-D) content with respect to the same content, and terminating the service with the first streaming server depending on a verification result; accessing, by the client, the second streaming server using the transferred content information; and receiving, by the client, the service for the 3-D content from the second streaming server.

The receiving of the 3-D content service may include receiving a streaming service for the 3-D content using the second streaming server when the 3-D streaming server providing the 3-D content having a quality, a dimension, and a viewpoint different from the SD content is added, while the client is receiving a streaming service with respect to the SD content from the first streaming server.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a configuration diagram of a system of providing a multimedia content streaming service in a general Internet Protocol (IP) network;

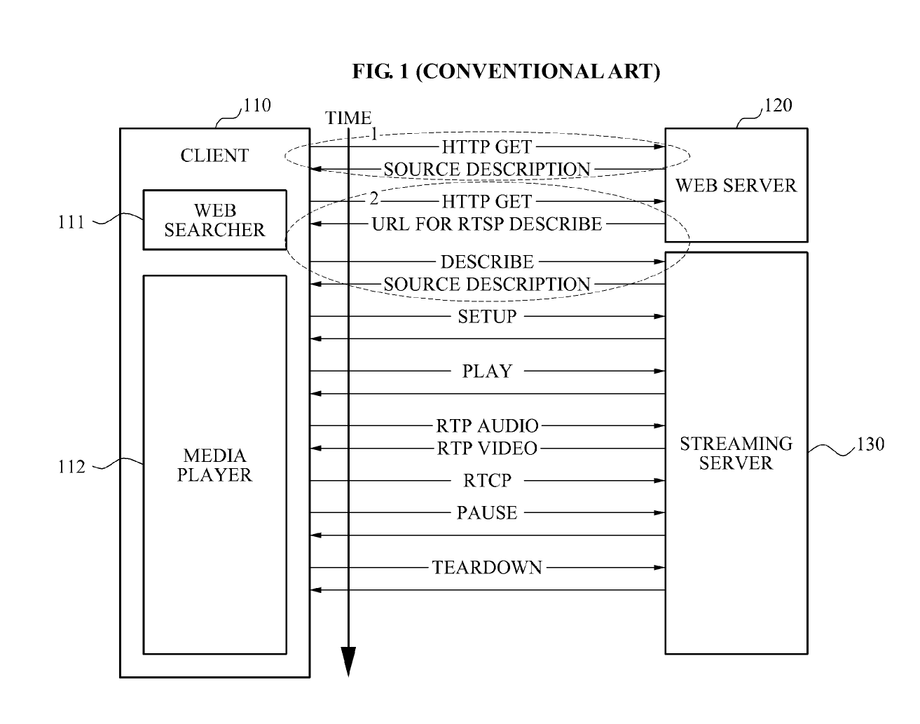

FIG. 2 is a diagram to describe a case where a client terminates a using secure digital (SD) content and then uses a high definition (HD) content according to an embodiment of the present invention;

FIG. 3 is a flowchart illustrating a method of terminating, by a client, a using SD content and then using an HD content according to an embodiment of the present invention;

FIG. 4 is a diagram to describe a case where a client terminates a using SD content and then uses a three-dimensional (3-D) content according to another embodiment of the present invention; and

FIG. 5 is a flowchart illustrating a method of terminating, by a client, a using SD content and then using a 3-D content according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

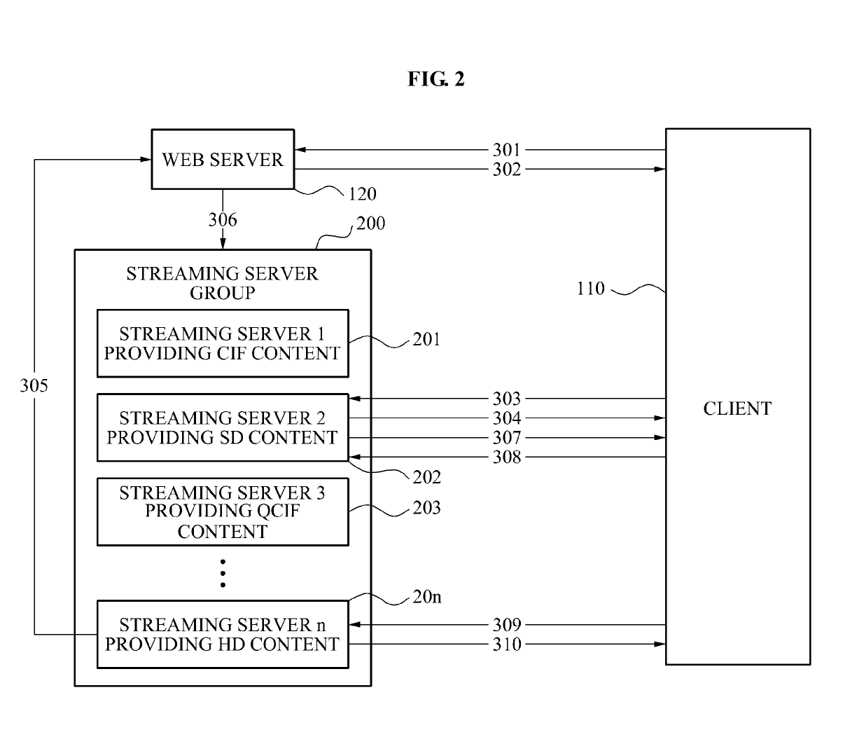

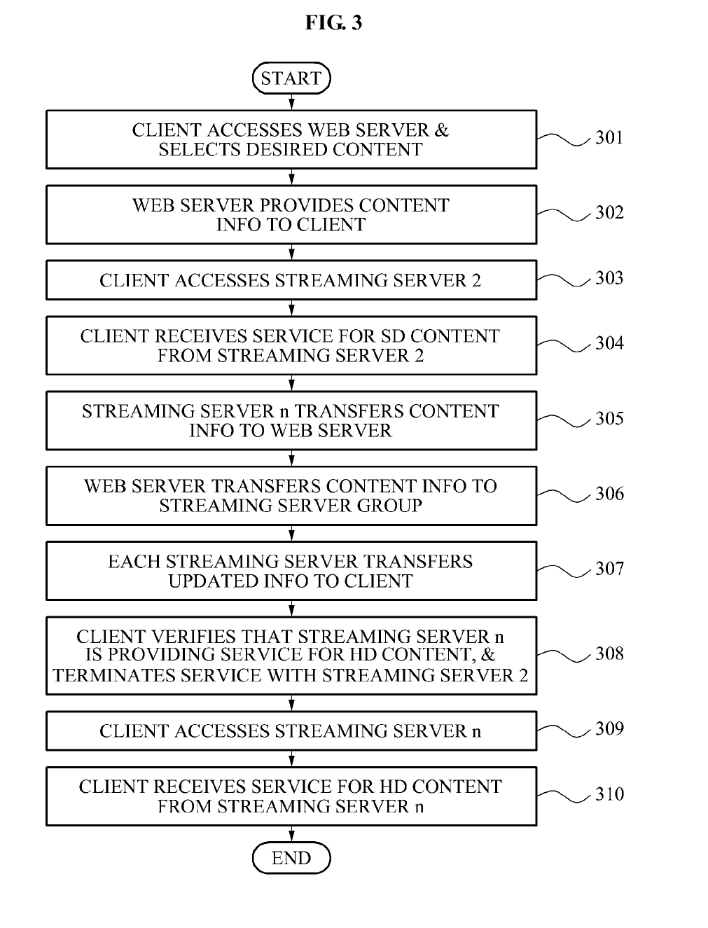

FIG. 2 is a diagram illustrating a case where a client terminates a using secure digital (SD) content and then uses a high definition (HD) content according to an embodiment of the present invention, and FIG. 3 is a flowchart illustrating a method of terminating, by a client, a using SD content and then using an HD content according to an embodiment of the present invention.

Referring to FIG. 2 and FIG. 3, in operation 301, a client 110 may access a web server 120 and select a content so as to receive a streaming service. For example, the client 110 may access the web server 120 and select an SD content so as to receive a streaming service desired by a user.

In operation 302, the web server 120 may provide information associated with the selected content to the client 110. For example, the web server 120 may provide, to the client 110, information associated with a streaming server (2) 202 servicing the SD content, as information associated with the SD content selected by the client 110. In this instance, a streaming server (1) 201, the streaming server (2) 202, a streaming server (3) 203, . . . , and a streaming server (n-1) (not shown) are providing a streaming service. The client 110 may receive content information associated with a content provided from each streaming server and session information associated with the content information.

In operation 303, the client 110 may access the streaming server (2) 202 so as to receive the service for the SD content. Specifically, the client 110 may access the streaming server (2) 202 providing a streaming service with respect to the SD content by referring to the provided content information.

In operation 304, the client 110 may receive the service for the SD content from the streaming server (2) 202. The streaming server (2) 202 is providing, to the client 110, the streaming service with respect to the SD content. The client 110 may receive content information associated with the content provided from the streaming server (2) 202 and session information associated with the content information.

In operation 305, a streaming server (n) 20n may start a streaming service and transfer content information to the web server 120. For example, the streaming server (n) 20n may start a streaming service with respect to an HD content and then transfer information associated with the HD content to the web server 120.

A streaming server group 200 corresponds to a server group providing a streaming service with respect to the same content, and may include the streaming server (1) 201 providing a Common Intermediate Format (CIF) content, the streaming server (2) 202 providing the SD content, the streaming server (3) 203 providing a Quarter Common Intermediate Format (QCIF) content, . . . , and the streaming server (n) 20n providing the HD content.

In operation 306, the web server 120 may add the transferred information and thereby transfer the added information to the streaming server group 200. Specifically, the web server 120 may transfer the updated content information to the streaming server group 200 servicing the same category of the content. For example, the web server 120 may add the transferred information and then transfer the added information to the streaming server (1) 201 through the streaming server (n) 20n.

As described above, according to an embodiment of the present invention, it is possible to monitor whether a new streaming server providing a new content service joins a streaming server group servicing the same category of a content.

In operation 307, the streaming server (2) 202 may transfer the updated content information to the client 110. Each streaming server may transfer the updated content information to the client 110 using “RTSP ANNOUNCE METHOD”. When the new streaming server (n) 20n providing the streaming service with respect to the same category of the content joins, the streaming server (2) 202 may receive, from the web server 120, join information of the new streaming server (n) 20n and update the content information based on an SDP and transfer the updated content information to the client 110.

The client 110 may interpret the updated content information, and may provide the interpreted content information to the user and thereby provide a user interface that enables the user to select the streaming service with respect to the content. For example, the client 110 may interpret the updated content information and thereby inform the user about that the streaming service with respect to the HD content is available, and may provide the user interface that enables the user to select the streaming service with respect to the HD content.

In operation 308, the client 110 may verify that the streaming server (n) 20n is servicing the HD content with respect to the same content and then terminate the service with the streaming server (2) 202. Specifically, when the streaming service with respect to the HD content is selected by the user, the client 110 may verify that the streaming server (n) 20n is providing the streaming service of the HD content with respect to the same content provided from the streaming server (2) 202, and may terminate the streaming service with respect to the SD content provided from the streaming server (2) 202.

In operation 309, the client 110 may access the streaming server (n) 20n. Specifically, the client 110 may access the streaming server (n) 20n providing the HD content so as to receive the HD content with respect to the same content provided from the streaming server (2) 202.

In operation 310, the client 110 may receive, from the streaming server (n) 20n, a service with respect to the HD content. Specifically, the client 110 may receive, from the streaming server (n) 20n providing the HD content, the streaming service with respect to the HD content.

According to an embodiment of the present invention, the content information updating method may include: monitoring whether a new streaming server joins a streaming server group servicing the same category of a content; updating content information associated with the content being serviced in the streaming server group, and transferring the updated content information to a client when the new streaming server joins; and providing a content service via the new streaming server according to a request of the client.

Accordingly, when the new streaming server is added to the streaming server group providing the streaming service with respect to the same content, the content information updating method may update content information associated with a content provided from the added streaming server using “RTSP ANNOUNCE METHOD”, and thereby enables the client to suspend a using SD content and then use an HD content.

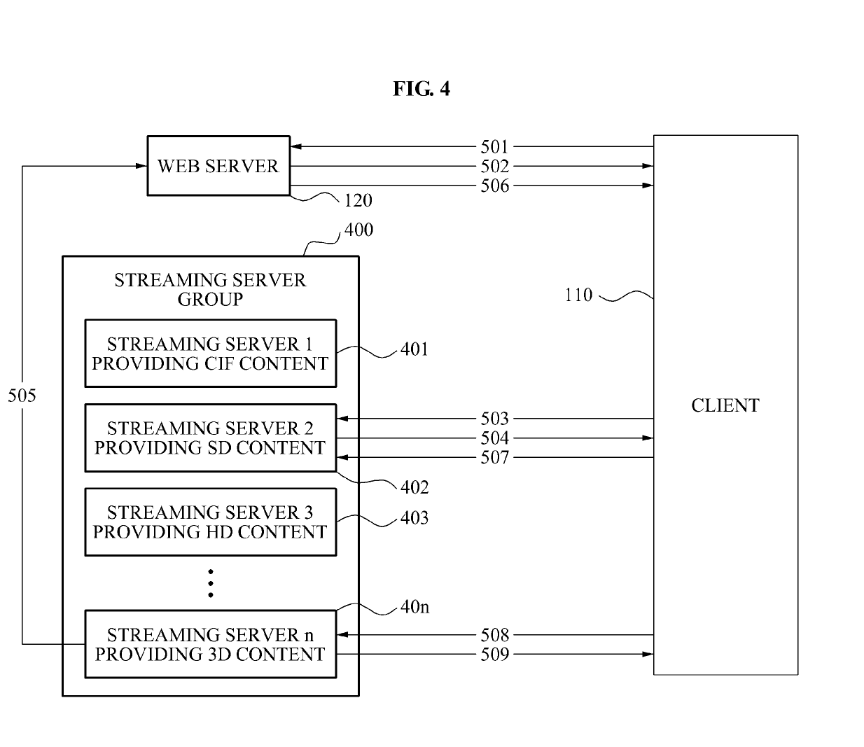

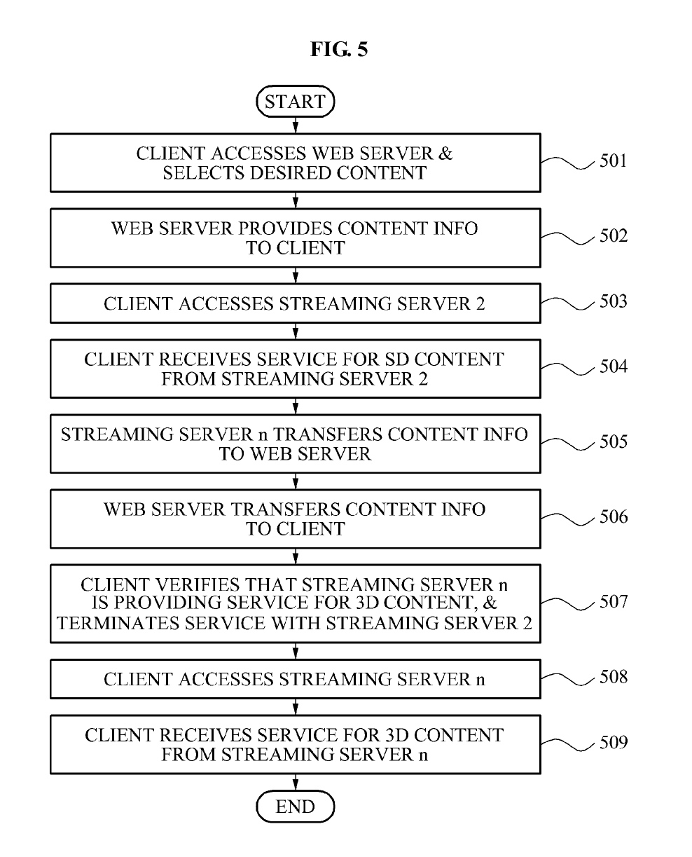

FIG. 4 is a diagram illustrating a case where a client terminates a using SD content and then uses a three-dimensional (3-D) content according to another embodiment of the present invention, and FIG. 5 is a flowchart illustrating a method of terminating, by a client, a using SD content and then using a 3-D content according to another embodiment of the present invention.

Referring to FIG. 4 and FIG. 5, in operation 501, a client 110 may access a web server 120 and select a content so as to receive a streaming service. For example, the client 110 may access the web server 120 and select an SD content so as to receive a streaming service desired by a user.

A streaming server group 400 corresponds to a server group providing a streaming service of a different quality, class, viewpoint, or dimension with respect to the same content. For example, the streaming server group 400 may include a streaming server (1) 401 providing a CIF content, a streaming server (2) 402 providing an SD content, a streaming server (3) 403 providing an HD content, . . . , a streaming server (n) 40n providing a 3-D content.

In operation 502, the web server 120 may provide information associated with the selected content to the client 110. For example, the web server 120 may provide, to the client 110, information associated with the streaming server (2) 402 servicing the SD content, as information associated with the SD content selected by the client 110.

In operation 503, the client 110 may access the streaming server (2) 402 so as to receive the service for the SD content. Specifically, the client 110 may access the streaming server (2) 402 providing the SD content so as to receive the streaming service with respect to the SD content selected by the user.

In operation 504, the client 110 may receive the service for the SD content from the streaming server (2) 402. Specifically, the client 110 may receive, from the streaming server (2) 402 providing the SD content, the streaming service with respect to the SD content.

In operation 505, a streaming server (n) 40n may start a streaming service and transfer content information to the web server 120. For example, the streaming server (n) 40n may start a streaming service with respect to the 3-D content and then transfer information associated with the 3-D content to the web server 120.

In operation 506, the web server 120 may add the transferred information and thereby transfer the added information to the client 110. Specifically, the web server 120 may update content information by adding information associated with the 3-D content, transferred from the streaming server (n) 40n, and may transfer the updated content information to the client 110. The web server 120 may transfer the updated content information containing the added content information to the client 110 currently using the SD content. For example, when the client 110 periodically requests the web server 120 for updated content information, the web server 120 may transfer the updated content information to the client 110. As another example, when the web server 120 manages content information and thereby updates the content information, the web server 120 may immediately transfer the updated content information to the client 110.

In operation 507, the client 110 may verify that the streaming server (n) 40n is servicing the 3-D content with respect to the same content and then terminate the service with the streaming server (2) 402. Specifically, the client 110 may verify that the streaming server (n) 40n providing the 3-D content desired by the user is providing the streaming service of the 3-D content with respect to the same content provided from the streaming server (2) 420, and then terminate the service with the streaming server (2) 402.

In operation 508, the client 110 may access the streaming server (n) 40n. Specifically, the client 110 may access the streaming server (n) 40n providing the streaming service with respect to the 3-D content desired by the user.

In operation 509, the client 110 may receive, from the streaming server (n) 40, the service with respect to the 3-D content. Specifically, when the streaming server (n) 40n providing a streaming service of a different quality, dimension, viewpoint, and the like, is added while the client 110 is receiving, from the streaming server (2) 402, the streaming service with respect to the SD content, and the user desires the streaming service with respect to the 3-D content, the client 110 may receive the streaming service with respect to the 3-D content using the accessed streaming server (n) 40n.

As described above, according to an embodiment of the present invention, when the streaming server (n) 40n starts the streaming service with respect to the 3-D content in the streaming server group 400 providing the streaming service with respect to the same content, the content information updating method enables the client 110 to suspend the using SD content and then use the 3-D content by providing, by the web server to the client 110, content information associated with the content provided from the streaming server (n) 40n.

According to embodiments of the present invention, when another streaming server providing a corresponding content using a different quality, a different dimension, a different viewpoint, and the like is added while a client is receiving a streaming service, a content information updating method enables the client to receive content information associated with the corresponding content provided by the another streaming server. In addition, when a user desires, the content information updating method enables the user to receive the streaming service with respect to the changed content using the other streaming server.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of updating content information, comprising:
monitoring whether a new streaming server joins a streaming server group servicing the same category of a content;
updating content information associated with the content being serviced in the streaming server group, and transferring the updated content information to a client when the new streaming server joins; and
providing a content service via the new streaming server according to a request of the client.

2. The method of claim 1, wherein the updating and the transferring comprises:
receiving join information from a web server when the new streaming server joins;
updating the content information based on a Session Description Protocol (SDP); and
transferring the updated content information to the client.

3. The method of claim 2, further comprising:
transferring the updated content information to the streaming server group servicing the same category of the content.

4. The method of claim 2, wherein the updating and the transferring comprises transferring, by the web server, the updated content information to the client using the content.

5. The method of claim 4, wherein the updating and the transferring comprises transferring, by the web server, the updated content information to the client when the client periodically requests the web server for the updated content information.

6. The method of claim 4, wherein:
the updating and the transferring comprises transferring, by the web server, the updated content information to the client when the content information is updated, and the web server manages the content information.

7. The method of claim 1, further comprising:
interpreting, by the client, the updated content information;
providing the interpreted content information to a user; and
providing a user interface enabling the user to select a streaming service with respect to a content of a class desired by the user.

8. A method of updating content information, the method comprising:
accessing, by a client, a web server and selecting a content corresponding to a desired streaming service;
providing, by the web server, content information associated with the selected content to the client;
accessing, by the client, a first streaming server so as to receive a service for a first class content;
receiving, by the client, the service for the first class content from the first streaming server;
starting, by a second streaming server providing a streaming service with respect to the same content, a service and transferring content information associated with the content to the web server;
adding, by the web server, the transferred content information and transferring the added content information to a streaming server group providing the streaming service with respect to the same content;
transferring, by each streaming server included in the streaming server group, updated content information to the client;
verifying, by the client, whether the second streaming server is servicing a second class content with respect to the same content, and terminating the service with the first streaming server depending on a verification result; and
receiving, by the client, the service for the second class content from the second streaming server,
wherein the streaming server group comprises the first streaming server and the second streaming server.

9. The method of claim 8, wherein the providing of the content information associated with the selected content comprises providing, by the web server, session information associated with content information of the first class content to the client when the first streaming server provides the first class content to the client.

10. A method of updating content information, the method comprising:
accessing, by a client, a web server and selecting a content corresponding to a desired streaming service;
providing, by the web server, content information associated with the selected content to the client;
accessing, by the client, a first streaming server so as to receive a service for a secure digital (SD) content;
receiving, by the client, the service for the SD content from the first streaming server;
starting, by a second streaming server providing a streaming service with respect to the same content, a service and transferring content information associated with the content to the web server;
adding, by the web server, the transferred content information and transferring the added content information to the client;
verifying, by the client, whether the second streaming server is servicing a three-dimensional (3-D) content with respect to the same content, and terminating the service with the first streaming server depending on a verification result;
accessing, by the client, the second streaming server using the transferred content information; and
receiving, by the client, the service for the 3-D content from the second streaming server.

11. The method of claim 10, wherein the receiving of the 3-D content service comprises receiving a streaming service for the 3-D content using the second streaming server when the 3-D streaming server providing the 3-D content having a quality, a dimension, and a viewpoint different from the SD content is added while the client is receiving a streaming service with respect to the SD content from the first streaming server.
